(19) United States
(12) Patent Application Publication
(10) Pub. No.: US 2025/0354821 A1
(43) Pub. Date: Nov. 20, 2025

(54) METHOD, SYSTEM AND COMPUTER PROGRAM PRODUCT FOR INTERACTIVE COMMUNICATION BETWEEN A MOVING OBJECT AND A USER

(71) Applicant: Porsche eBike Performance GmbH, Ottobrunn (DE)

(72) Inventor: Klaus FUOSS, Balingen (DE)

(73) Assignee: Porsche eBike Performance GmbH, Ottobrunn (DE)

(21) Appl. No.: 18/870,523

(22) PCT Filed: May 24, 2023
(86) PCT No.: PCT/EP2023/063969

§ 371 Date: Nov. 29, 2024

(30) Foreign Application Priority Data
Jun. 2, 2022 (DE) 10 2022 113 992.1

(51) Int. Cl. G01C 21/36; H04W 4/024; H04W 4/44

(52) U.S. Cl. CPC G01C 21/3629; H04W 4/024; H04W 4/44

(57) ABSTRACT

A method provides interactive communication between a moving object (10) and a user traveling along a route that has scenarios in a temporal sequence. The method includes using first sensors (340) of the moving object (10) for capturing sensor data (350) relating to an environment; generating at least one scenario from the sensor data (350) for a traffic event in the environment; capturing first user-specific data (250) in the form of voice messages, text messages and/or images, and/or second user-specific data (290) in the form of measurement signals from second sensors (270). The method generates a user-specific assessment function (470) from the first data (250) and the second data (290); and uses a software application (750) of the output module (700) to create output data (770). The software application (750) assesses the generated scenarios with the assessment function (470) and generates user-specific output data that is output to the user.

### FIELD OF THE INVENTION

The invention relates to a method, a system and a computer program product for interactive communication between a moving object and a user.

### BACKGROUND OF THE INVENTION

It is known that information for navigating a motor vehicle along a route by means of a navigation system is displayed on a display in the motor vehicle. In addition, further information is output via an audio system as voice messages. Navigation systems are also known for other moving objects, such as a bicycle, in particular an electric bicycle, and their provided information is displayed on a display. However, it is often difficult for a user of a bicycle to read the information on the display correctly, because, for example, glare effects from sunlight occur or a travel situation, such as traveling on a forest path, takes the entire attention of the cyclist. In such a situation, it would be helpful for a cyclist to obtain the necessary navigation information primarily in the form of audio information, which, in addition to direct voice messages, may also include warning signals or background music adapted to a specific travel situation.

In addition, it would be desirable if the presented information were oriented more to the needs of the respective user while traveling along a route. For example, there are cyclists who want very detailed support through navigation information, while others, for example, simply need support in extreme situations. Especially the taste in music is very different for different cyclists. Since the environment also changes while traveling along a route, for example from a busy street on the outskirts of the city to a forest path, the atmosphere of the environment can influence the preferences of a cyclist. Therefore, it may be desirable to establish synchronicity between the environment and a piece of music. For example, epic sounds are appreciated when passing through special locations such as a high bridge over a valley or when traveling out of a tunnel, while moderate and quiet sounds are better suited when traveling through a section of forest.

In addition, applications of improved communication in other moving objects are desirable. For example, people with visual impairments are dependent on audio messages to find their way in an environment. However, previous support devices, such as rollators, have neither the required sensors for capturing the environment nor a satisfactory interactive communication device. But it is especially in this area that it is desirable to increase the safety of a user, to reliably capture the environment and to transmit appropriate warnings to the user, in particular by means of a voice message in real time. Again, there are different needs of users regarding the quantity and quality of audio messages.

Another area of application is industrial vehicles in production, which could be used more efficiently and safely through individualized communication.

There is therefore a need for an individual design of the communication between a user and a navigation system of a moving object or the audio environment of a user, since this can increase both the travel experience or movement experience and safety.

DE 10 2020 201 956 A1 discloses a determination device which determines the physical condition of the driver on the basis of travel information. The information can be output via a display, a loudspeaker, or an interface. A learning model for machine learning is also integrated.

DE 10 2018 126 410 A1 discloses a user interface for a vehicle that detects output events and outputs basic information about a vehicle function. In addition, additional information can be obtained from devices located outside the vehicle via the interface.

U.S. Pat. No. 11,697,468 discloses a bicycle assembly which outputs information about the operating state of the bicycle components via a loudspeaker and uses noise signals for control.

US2020/398,841 discloses an ECU capable of transmitting information to the driver as voice messages.

DE 10 2019 103716 A1 discloses a control device that uses biometric information such as voice inputs for authentication.

U.S. Pat. No. 9,878,210 discloses a bicycle in which information can be input and/or output as voice messages.

DE 10341890 A1 discloses a bicycle computer which can be controlled by means of a voice message

An object of the present invention is, therefore, to specify possibilities for interactive communication between a moving object and a user, which is tailored to the individual needs of the user, when traveling along a route in order to thereby improve safety and comfort while traveling along the route with the moving object.

### SUMMARY OF THE INVENTION

According to a first aspect, the invention provides a method for interactive communication between a moving object and a user when traveling along a route with a variety of scenarios. A scenario represents a traffic event in a temporal sequence. The method comprises the method steps of:
capturing sensor data relating to an environment of the moving object by means of first sensors of a sensor apparatus of the moving object
transmitting the sensor data to a scenario module;
generating at least one scenario from the sensor data for the traffic event in the environment of the moving object by means of a software application of the scenario module and transmitting the generated scenario to an output module;
capturing first user-specific data, in particular in the form of voice messages, text messages and/or images, and/or second user-specific data in the form of measurement signals from second sensors, wherein the first user-specific data are input by a user by means of a user interface, and wherein the second sensors measure physiological and/or physical parameters of the user, in particular;
transmitting the first data and/or the second data to an assessment module;
generating a user-specific assessment function from the first data and the second data by means of a software application and transmitting the user-specific assessment function to an output module
creating output data by means of a software application of the output module, wherein the software application assesses the generated scenarios with the user-specific assessment function and generates user-specific output data therefrom;
outputting the user-specific output data to the user.

In one advantageous development, the first sensors of the sensor apparatus comprise one or more radar systems with one or more radar sensors, and/or one or more LIDAR systems for optical distance and speed measurement, and/or one or more image-recording 2D/3D cameras in the visible range and/or in the IR range and/or in the UV range, and/or GPS systems. Additionally, one or more of the second sensors is/are designed as a blood pressure monitor and/or heart rate monitor and/or temperature gage and/or acceleration sensor and/or speed sensor and/or capacitive sensor and/or inductive sensor and/or voltage sensor.

In one advantageous embodiment, the software application of the assessment module and/or the software application of the scenario module and/or the software application of the output module comprise(s) artificial intelligence and machine learning algorithms, in particular deep learning with, for example, at least one convolutional neural network (CNN) and/or at least one reinforcement learning agent (LV), for generating the user-specific assessment function and/or for generating scenarios from the recorded sensor data and/or for generating output data.

In a further embodiment, data from a database are used to generate the output data.

In some embodiments, the scenario module and the output module are integrated in a cloud computing infrastructure. In particular, a 5G mobile radio connection or 6G mobile radio connection may be used for the data connection of the sensor apparatus to the scenario module or the cloud computing infrastructure and for the data connection of the input module to the assessment module or the cloud computing infrastructure for real-time data transmission.

In the further development, a first version of the assessment function is created in a training phase by means of a training set of user-specific data.

In one advantageous embodiment, the output data are audio sequences, in particular in the form of voice messages, warning tones and/or music titles.

The scenarios are designated by labels for a classification by the assessment function.

According to a second aspect, the invention provides a system for interactive communication between a moving object and a user when traveling along a route with a variety of scenarios. A scenario represents a traffic event in a temporal sequence. The system comprises an input module, a sensor apparatus, an assessment module, a scenario module, and an output module. The sensor apparatus is designed to capture sensor data relating to an environment of the moving object by means of first sensors and to transmit the sensor data to the scenario module. The scenario module is designed to generate at least one scenario from the sensor data for the traffic event in the environment of the moving object by means of a software application and to transmit the generated scenario to the output module. The input module is designed to capture first user-specific data, in particular in the form of voice messages, text messages and/or images, and/or second user-specific data in the form of measurement signals from second sensors, and to transmit the first data and/or the second data to an assessment module, wherein the first user-specific data are input by a user by means of a user interface, and wherein the second sensors measure physiological and/or physical parameters of the user, in particular. The assessment module is designed to generate a user-specific assessment function from the first data and the second data by means of a software application and to transmit the user-specific assessment function to the output module. The output module is designed to create output data by means of a software application, wherein the software application assesses the generated scenarios with the user-specific assessment function and generates user-specific output data therefrom, and to output the user-specific output data directly or indirectly to the user by means of a transmission apparatus such as a microphone or a headphone.

In one advantageous development, the first sensors of the sensor apparatus comprise one or more radar systems with one or more radar sensors, and/or one or more LIDAR systems for optical distance and speed measurement, and/or one or more image-recording 2D/3D cameras in the visible range and/or in the IR range and/or in the UV range, and/or GPS systems, and one or more of the second sensors is/are designed as a blood pressure monitor and/or heart rate monitor and/or temperature gage and/or acceleration sensor and/or speed sensor and/or capacitive sensor and/or inductive sensor and/or voltage sensor.

The software application of the assessment module and/or the software application of the scenario module and/or the software application of the output module may comprise artificial intelligence and machine learning algorithms, in particular deep learning with, for example, at least one convolutional neural network (CNN) and/or at least one reinforcement learning agent (LV), for generating the user-specific assessment function and/or for generating scenarios from the recorded sensor data and/or for generating output data.

In particular, further data from a database are used to generate the output data.

In a further embodiment, the assessment module, the scenario module and the output module are integrated in a cloud computing infrastructure. In particular, a 5G mobile radio connection or 6G mobile radio connection may be used for the data connection of the sensor apparatus to the scenario module or the cloud computing infrastructure and for the data connection of the input module to the assessment module or the cloud computing infrastructure for real-time data transmission.

In a further development, a first version of the assessment function is created in a training phase by means of a training set of user-specific data.

The output data may be audio sequences, in particular in the form of voice messages, warning tones and/or music titles.

According to a third aspect, the invention relates to a computer program product comprising an executable program code that is configured to carry out the method according to the first aspect when executed.

The invention is explained in more detail below using an exemplary embodiment illustrated in the drawings.

### BRIEF DESCRIPTION OF THE DRAWINGS

FIG. 1 is a block diagram for explaining an exemplary embodiment according to the invention.

FIG. 2 is a flowchart for explaining the individual method steps of a method according to the invention.

FIG. 3 is a block diagram that schematically shows a computer program product according to one embodiment of the third aspect of the invention

Additional features, aspects and advantages of the invention or of its exemplary embodiments become apparent from the detailed description in conjunction with the claims.

### DETAILED DESCRIPTION

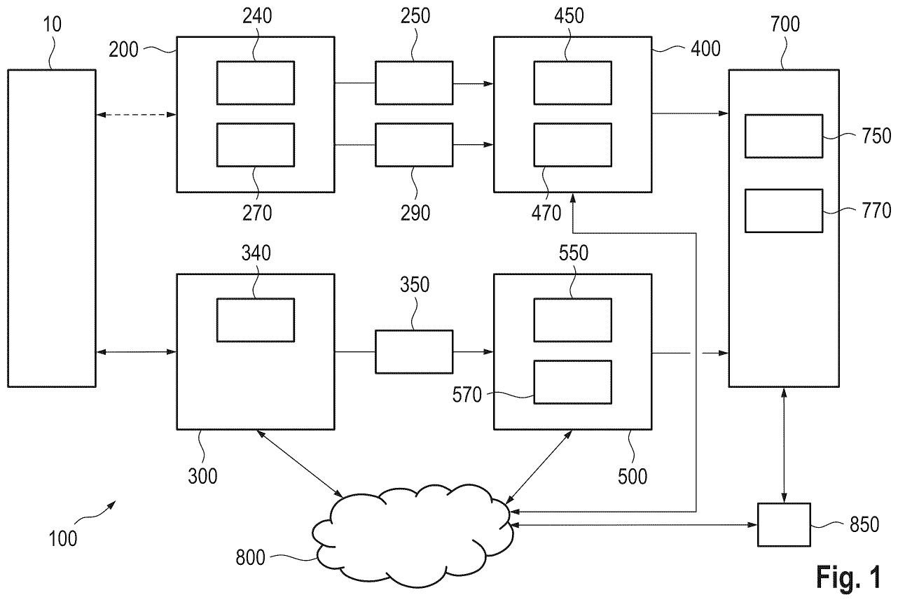

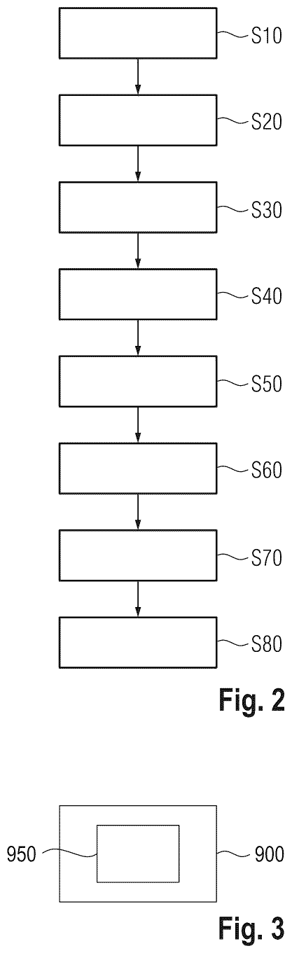

FIG. 1 shows a system 100 according to the invention for interactive communication between a moving object 10 and a user. The system 100 comprises the moving object 10 and a plurality of modules that can comprise both integrated or assigned processors and/or memory units.

In particular, the moving object 10 is an electric bicycle. However, it can also be a motor vehicle, an autonomously driving motor vehicle, an agricultural vehicle such as a combine harvester, a robot in production or in service and care facilities, or a watercraft or a flying object such as an air taxi. In one embodiment, the moving object 10 may also be an auxiliary device for people with visual impairments in order to move safely along a route, such as in the form of a rollator or a similar rolling device. The moving object 10 is used by a user as a means of transport or as a means of support when traveling along a route.

A “module” can therefore be understood in connection with the invention as meaning, for example, a processor and/or a memory unit for storing program instructions. For example, the module is specifically configured to execute the program instructions in such a way as to implement or realize the method according to the invention or a step of the method according to the invention.

A “processor” can be understood in connection with the invention as meaning, for example, a machine or an electronic circuit or a powerful computer. In particular, a processor may be a main processor (Central Processing Unit, CPU), a microprocessor or a microcontroller, for example an application-specific integrated circuit or a digital signal processor, possibly in combination with a memory unit for storing program instructions, etc. A processor can also be understood as meaning a virtualized processor, a virtual machine, or a soft CPU. It may also be, for example, a programmable processor which is equipped with configuration steps for carrying out said method according to the invention or is configured with configuration steps in such a way that the programmable processor realizes the features according to the invention of the method, the component, the modules, or other aspects and/or partial aspects of the invention. In addition, highly parallel computing units and powerful graphics modules can be provided.

A “memory unit” or “memory module” and the like can be understood in connection with the invention as meaning, for example, a volatile memory in the form of random-access memory (RAM) or a permanent memory such as a hard disk or a data carrier, or a removable memory module, for example. However, the memory module can also be a cloud-based storage solution.

The sensor apparatus 300 of the moving object 10 comprises sensors 340 which capture sensor data 350 from the environment of the object 10 such as road markings, vehicles, persons, guardrails, etc. and transmit said data to the scenario module 500.

Sensor data 350 should be understood in connection with the invention as meaning both raw data and already processed data from the measurement results of the sensors 350 and, if appropriate, further data sources.

The sensors 340 of the sensor apparatus 300 may comprise in particular one or more radar systems with one or more radar sensors, one or more LIDAR systems (Light Detection and Ranging) for optical distance and speed measurement, one or more image-recording 2D/3D cameras in the visible range, but also in the IR and UV range, and/or GPS systems.

In particular, the 2D/3D image-recording camera is designed as an RGB camera in the visible range with the primary colors of blue, green and red. However, a UV camera in the ultraviolet range and/or an IR camera in the infrared range may also be additionally provided. The cameras, which differ in terms of their recording spectrum, can thus model different lighting conditions in the recording region. It is also provided that a 3D camera is designed as a stereo camera.

The recording frequency of the sensor apparatus 300 is designed in particular for fast speeds of the object 10 and can record sensor data 350 with a high image recording frequency. Furthermore, the sensor apparatus 300 can be equipped with a microphone for the purpose of capturing acoustic signals. This makes it possible to record tire rolling noises or engine noises.

In addition, it can be provided that the sensor apparatus 300 automatically starts the image recording process when there is a significant change in the area of the recording region of the sensor apparatus 300, for example when a significant change in a traffic situation is recognizable. This enables a selective data capture process and only relevant sensor data 350 are processed by the scenario module 500. This enables more efficient use of computing capacities.

In particular, provision is made to use, as a camera type for one or more cameras, a weatherproof action camera which can be arranged in particular in the exterior region of the object 10. An action camera has wide-angle fisheye lenses, making it possible to achieve a visible radius of approximately 180°. This allows a comprehensive representation of a road ahead. Action cameras can usually record videos in full HD (1920×1080 pixels), but action cameras can also be used in ultra HD or 4K (at least 3840×2160 pixels), resulting in a significant increase in the image quality. The image recording frequency is usually 60 frames per second in 4K and up to 240 frames per second in full HD. In addition, an integrated image stabilizer may also be provided. In addition, action cameras are often equipped with an integrated microphone. In addition, differential signal processing methods can be used to specifically suppress background noises.

The position at which a camera is attached to the object 10 determines which recording region can be recorded by the camera. It may be provided in particular that the recording regions of two or more cameras overlap, for example in order to generate a panoramic representation during the further image processing. This allows the spatial environment of a moving object 10 to be comprehensively captured. In addition to the recording region to be strived for, however, the technically possible attachment positions and a sensible integration into the design of the frame must also be taken into account in the case of an object 10 such as a bicycle.

Radar sensors can be used for longer distances of up to 250 meters and have the advantage of being independent of weather and lighting conditions. The performance of a radar depends on many factors, such as the selected hardware components, the software processing, and the radar echo. For example, the radar accuracy is less accurate at a lower signal-to-noise ratio than at a high signal-to-noise ratio. In addition, the installation position is crucial for a high performance of a radar sensor, since effects such as multipath propagation and distortion caused by covers affect the detection accuracy.

In addition to image-recording cameras and radar sensors, LIDAR sensors are an important type of sensor for the perception of the environment for moving objects 10. As with cameras and radar sensors, the surroundings can be recorded and distances to other environmental objects can be measured. In particular, 3D LIDAR sensors can record detailed information about an environmental object by means of a high scanning rate. Compared to radar sensors, LIDAR sensors are distinguished by a higher spatial and depth resolution. For LIDAR sensors, a distinction is made between a mechanical scanning LIDAR with mechanically rotating components for scanning a laser beam and an SSL LIDAR (Solid State Lidar) without moving components. An SSL LIDAR system typically consists of a laser source or a laser diode, optical elements such as lenses and diffusers, beam control elements, photodetectors, and signal processing units. The recording region of SSL LIDAR is smaller, but the costs are lower and the reliability is higher.

Furthermore, a GPS connection is advantageously provided in order to determine the geographical location of the object 10 and to assign this to the recorded sensor data 350.

The sensor data 350 relating to the environment of the object 10 that are captured by the sensor apparatus 300 are forwarded to the scenario module 500 by means of data connections in order to derive a scenario from the sensor data 350. Since the scenario module 500 does not have to be located in or on the moving object 10, a wireless data connection is provided in particular and may be designed, for example, as a mobile radio connection and/or a near field data connection such as Bluetooth®, Ethernet, NFC (near field communication) or Wi-Fi®.

In particular, it is provided that the scenario module 500 is integrated in a cloud computing infrastructure 800. This makes it possible to ensure a fast calculation, since cloud-based solutions offer the advantage of high and therefore fast computing powers. A 5G mobile radio connection or 6G mobile radio connection is used in particular for the communication of the sensor apparatus 300 with the scenario module 500 or the cloud computing infrastructure 800, since real-time data transmission can be carried out in this way. The sensor apparatus 300 is equipped for this purpose with the corresponding mobile radio modules.

5G is the fifth-generation mobile radio standard and, compared to the 4G mobile radio standard, is distinguished by higher data rates of up to 10 Gbit/sec, the use of higher frequency ranges such as 2100, 2600 or 3600 megahertz, an increased frequency capacity and thus an increased data throughput and real-time data transmission, since up to one million devices per square kilometer can be addressed simultaneously. The latencies range from a few milliseconds to less than 1 ms, allowing real-time transmissions of data and calculation results. Therefore, the sensor data 350 recorded by the sensor apparatus 300 can be forwarded in real time to the scenario module 500.

As a result of the integration of the scenario module 500 in a cloud computing infrastructure 800 in conjunction with a 5G mobile radio connection, processing of the sensor data 350 recorded by the sensor apparatus 300 in real time can thus be ensured. In order to protect the connection to the cloud computing infrastructure 800 by means of a mobile radio connection, cryptographic encryption methods are provided, in particular.

The scenario module 500 has a software application 550 which determines a scenario 370 from the sensor data 350 recorded during a certain period of time. A traffic event in a temporal sequence is referred to as a scenario in the context of the invention. An example of a scenario is traveling along a forest path, a road in urban traffic, a bridge, turning into a turn lane, traveling through a tunnel, entering a traffic circle, or stopping in front of a pedestrian crossing. In addition, specific visibility conditions, for example due to dusk or a high level of sunlight, as well as environmental conditions such as the weather and the season, the traffic volume, and certain geographical topographical conditions, can affect a scenario.

For example, a scenario can be defined by various parameters and associated parameter values. The parameter values define the value range of a parameter. The parameters include, for example, a moving object such as a motor vehicle, a stationary object such as a building, a road configuration such as a highway, a speed, a road sign, a traffic light, a tunnel, a traffic circle, a turn lane, an acceleration, a direction, an angle, a radius, a location, a traffic volume, a topographical structure such as a slope, a time, a temperature, a precipitation value, the weather, a season.

The software application 550 comprises in particular artificial intelligence and machine image analysis algorithms in order to select and classify the sensor data 350 and to determine one or more scenarios 370 therefrom. Advantageously, the software application 550 uses algorithms from the field of machine learning, preferably deep learning with, for example, at least one convolutional neural network (CNN) and/or at least one reinforcement learning agent (LV) for creating scenarios from the recorded sensor data 350.

A neural network consists of neurons that are arranged in a plurality of layers and are connected to one another in different ways. A neuron is able to receive information from the outside or from another neuron at its input, assess the information in a certain way and forward it in a modified form at the neuron output to another neuron or output it as the final result. Hidden neurons are arranged between the input neurons and output neurons. Depending on the network type, there may be multiple layers of hidden neurons. They are responsible for forwarding and processing the information. Output neurons eventually deliver a result and output it to the outside world. The different arrangement and linking of the neurons results in different types of neural networks such as a feed-forward network (FFN), a recurrent network (RNN) or a convolutional neural network (CNN). The networks can be trained through unsupervised or supervised learning.

In particular, the convolutional neural network (CNN) is very well suited to machine learning and artificial intelligence (AI) applications in the field of image and voice recognition, since it has a plurality of convolutional layers. The method of operation of a convolutional neural network is modeled in a certain way on biological processes and the structure is comparable to the visual cortex of the brain. Conventional neural networks consist of fully or partially linked neurons in a plurality of planes, and these structures reach their limits when processing images because there would have to be a number of inputs corresponding to the number of pixels. The convolutional neural network is composed of various layers and is basically a partly locally linked neural feed-forward network. The individual layers of the CNN are the convolutional layer, the pooling layer, and the fully linked layer. The convolutional neural network (CNN) is therefore suitable for machine learning and artificial intelligence applications with large amounts of input data such as in image recognition. The network operates reliably and is resistant to distortion or other optical changes. The CNN can process images recorded in different lighting conditions and perspectives. It still recognizes the typical features of an image. Since the CNN comprises a plurality of local partially linked layers, it requires much less storage space than fully linked neural networks, since the convolutional layers significantly reduce the storage requirements. This also shortens the training time of a CNN, especially when using modern graphics processors.

The scenario 570 created by the software application 550 can also be provided with one or more labels, such as a label that describes a safety index. Thus, a detected scenario 570, which is traveled through by the moving object 10, can be assessed with a low safety index, with the result that it is not important for the safety of the moving object 10 or the user, whereas a label with a high safety index indicates that the scenario that has been traveled through has a high significance for the safety of the user.

Furthermore, the output module 700 can be connected to a database 850 in which historical data in the form of images, graphics, time series, route planning, characteristic variables, etc. are stored. In addition, the database 850 stores audio sequences, such as voice messages, pieces of music, and warning tones.

“Database” should be understood as meaning both a storage algorithm and the hardware in the form of a memory unit. In particular, the database 850 can also be integrated into the cloud computing infrastructure 800.

The input module 200 is provided for the purpose of capturing first user-specific data 250 and second user-specific data 290. The first user-specific data 250 are data input by a user by means of a user interface 240. The user interface 240 is therefore designed to input and generate data 250 in the form of text messages and/or voice messages and/or images and graphics. For the input of the data 250, a keyboard, a microphone, a camera and/or a display designed as a touch screen are provided in particular.

In addition, the input module 200 is connected to second sensors 270 which capture physiological and/or physical reactions of a user when traveling along a route with the moving object 10. The sensors 270 for capturing physiological and/or physical parameters of a user are in particular sensors which are attached to the body of the user or are connected to the body. In particular, a sensor 270 may be designed as a blood pressure monitor, as a heart rate monitor and/or a temperature gage. A possible embodiment of a sensor 270 is a fitness wristband such as from FITBIT® or other manufacturers, which continuously measure the heart rate. These fitness bands can be attached to the user's wrist and the measured data can be easily read out. The pulse, and thus the heart rate, in these devices is generally measured optically by means of the changed reflection behavior of emitted LED light in the case of a change in the blood flow due to the contraction of the blood capillary vessels when the heart beats. The device typically emits light in the green wavelength range into the tissue on the wrist and measures the reflected light. Since blood strongly absorbs the light in this wavelength range, the measured light intensity fluctuates when the blood vessels pulsate, from which the heart rate can be determined. In a stressful situation, the heart rate accelerates, and so the changed heart rate is a good indicator of the occurrence of a stressful situation.

However, garments equipped with sensors or smart watches or corresponding glasses can also be used. In addition, optical sensors such as a camera can be used to record the change in a user's facial expressions and gestures, such as dilated pupils as a sign of a fear reaction. Infrared cameras for measuring the skin surface temperature and sensors for detecting perspiration are also conceivable. Sensors inside the body, such as so-called smart pills, which are in the form of pills and can be swallowed, are also conceivable. They can detect chemical reactions in the body and send the determined data to an external storage apparatus, for example via radio connection.

A sudden change in a parameter, such as the heart rate, indicates the identification of a dangerous situation or a high level of physical exertion by a user. For example, a characteristic deviation from a normal value is therefore defined as a limit value that indicates such an extreme situation.

Furthermore, direct physical reactions of the driver, such as the steering activity and brake pedal actuation, can be captured. This can be the sudden and powerful actuation of the brake device by a user, for example if he wants to avoid the risk of a collision with another object. The brake device may be provided with brake sensors that register a rapid and sudden change in the braking behavior. The sensors can be designed as capacitive acceleration sensors. In addition, it is possible to use pressure sensors, for example on the steering wheel of a bicycle, which detect a firmer grip on the steering wheel and thus a greater pressure exertion when the user grasps the steering wheel more firmly due to the increase in muscle tone occurring during a stressful situation. Even fast and jerky steering movements of the steering wheel can be captured with appropriate motion sensors. Here too, characteristic deviations from a normal value indicate such an extreme situation.

However, a dangerous situation can also lead to spontaneous utterances by the user, for example as an expression of anger. These acoustic signals can be recorded by a microphone of the user interface 240.

The user-specific data 250 that have been input and recorded are passed on to the assessment module 400. The assessment module 400 has a software application 450 which creates an assessment function 470 from the user-specific data 250. The assessment function 470 represents an individual user profile for the assessment and interpretation of the scenarios determined by the scenario module 500. For the creation of the assessment function 470, the software application 450 uses artificial intelligence algorithms such as, in particular, deep learning with, for example, at least one convolutional neural network (CNN) and/or at least one reinforcement learning agent (LV).

In a training phase, a first version of the assessment function 470 is created by means of a training set of user-specific data 250, 290. For example, a user can input that he prefers a sporty driving style of the moving object 10. Since the software application 450 comprises self-learning algorithms, the assessment function 470 can be continuously improved over time by the continuous use of the moving object 10 and the generation of user-specific data 250, 290 during use, with the result that it adapts better to the needs and preferences of a user.

The assessment function 470 is passed on to the output module 700. The output module 700 comprises a software application 750 which assesses the scenarios 570 by means of the assessment function 470 and outputs the corresponding output data 770 for communication with the user. The output data 770 are primarily audio sequences such as voice outputs that indicate a specific scenario, for example a possible collision with another object if the user maintains the current speed. If the output data 770 are audio sequences, these can be output, for example, via a loudspeaker arranged on the moving object 10. However, it may also be provided that the user receives the respective audio sequences via a corresponding headset, an in-ear headphone, a loudspeaker integrated in a protective helmet, etc.

However, since the scenarios 570 are assessed with the user-specific assessment function 470, not every scenario is notified to the user. If, for example, an assessment function 470 personalized for the user stores the fact that the user prefers a sporty driving style, scenarios 570, which are considered non-critical, are not communicated to the user, since the focus is on critical scenarios 570. If, on the other hand, the assessment function 470 stores the fact that the user prefers a comfortable driving style, the user is already alerted to rather harmless scenarios 570.

In addition to the type of driving style, an assessment of the user's health status can be included in the assessment function 470, for example on the basis of the data 290 relating to the physiological condition of the user. This may result, for example, in the fact that, when a certain speed of the moving object 10 is exceeded, the output data 770 contain a voice message that advises the user to reduce his speed.

Furthermore, it is possible that the assessment function 470 has an emotionality index in order to connect certain scenarios 570 to a desired emotionality. For example, upon achieving a goal, a user can receive a voice message in the form of a motivational message, such as “Great job—you've successfully achieved your goal.” In addition, it may be provided that a certain musical sequence, such as a certain piece of music, is played for this purpose. Voice reproduction may also vary in terms of pitch, vocal speed and emotionality.

Furthermore, it may be provided that, when traveling through a certain scenario, for example a piece of forest, correspondingly quiet background music is played, whereas, when traveling on a busy road, a different music style is selected.

A method for interactive communication between a moving object 10 and a user when traveling along a route with a variety of scenarios comprises the following method steps:

In a step S10, sensor data 350 relating to an environment of the moving object 10 are captured by means of first sensors 340 of a sensor apparatus 300 of the moving object 10.

In a step S20, sensor data 350 are transmitted to a scenario module 500.

In a step S30, at least one scenario is generated from the sensor data 350 for the traffic event in the environment of the moving object 10 by means of a software application 550 of the scenario module 500 and transmitted to an output module 700.

In a step S40, first user-specific data 250, in particular in the form of voice messages, text messages and/or images, and/or second user-specific data 290 in the form of measurement signals from second sensors 270 are captured by an input module 200, wherein the first user-specific data 250 are input by a user by means of a user interface 240, and wherein the second sensors 270 measure physiological and physical parameters of the user, in particular.

In a step S50, the first data 250 and/or the second data 290 are transmitted to an assessment module 400.

In a step S60, a user-specific assessment function 470 is generated from the first data 250 and the second data 290 by means of a software application 450 and transmitted to the output module 700.

In a step S70, output data 770 are created by means of a software application 750 of the output module 700, wherein the software application 750 assesses the at least one generated scenario with the user-specific assessment function 470 and generates user-specific output data 770 therefrom.

In a step S80, the user-specific output data 770 are output to the user.

By generating a user-specific assessment function according to the invention, the information offered to a user about a scenario, which the user travels through or passes with a moving object 10, can be individually adapted to the needs and preferences of the user. The moving object 10 comprises a sensor apparatus that is used to reliably capture data relating to the environment. A specific scenario can be respectively classified from the data by means of a software application. Whereas a scenario generated in this manner is usually communicated to a user in unfiltered form, for example by means of a navigation apparatus, the relevant scenarios are assessed and therefore extracted according to the invention by means of the user-specific assessment function. Especially during a training phase, the assessment function is trained using user-specific data, such as in particular information on the driving style and safety level. It may be provided that the user must answer a corresponding list of questions before starting the system according to the invention. For this purpose, for example, it is possible to develop a specific app which can be called up by the user, for example from his cellphone, with the result that the assessment function is trained at a location separate from the moving object. In addition, the assessment function evolves on a self-learning basis, since it has appropriate learning algorithms that adapt to a changing user behavior. For example, one user can request information about the cultural and historical background of a landmark along the route, whereas another user prefers information about his current physiological data, such as his pulse rate.

In one preferred embodiment, the moving object is formed as an electric bicycle. In addition, other applications for improved communication are conceivable for other moving objects, such as industrial vehicles in production or support devices for people with visual impairments, such as rollators. An improved sensor system on these devices means that the environment can be reliably captured and the resulting information relevant to a user, in particular in the form of required warnings, can be transmitted to the user, for example by means of a voice message, in real time, whereby the safety of the user can be significantly increased.

1. A method for interactive communication between a moving object (10) and a user when traveling along a route with a variety of scenarios, wherein a scenario represents a traffic event in a temporal sequence, the method comprising:
using first sensors (340) of a sensor apparatus (300) of the moving object (10) for capturing (S10) sensor data (350) relating to an environment of the moving object (10);
transmitting (S20) the sensor data (350) to a scenario module (500);
using a software application (500) of the scenario module (500) and transmitting the generated scenario to an output module (700) for generating (S30) at least one scenario from the sensor data (350) for the traffic event in the environment of the moving object (10);
capturing (S40) first user-specific data (250) as voice messages, text messages and/or images, and/or second user-specific data (290) as measurement signals from second sensors (270), the first user-specific data (250) being input by a user by means of a user interface (240), and the second sensors (270) measuring physiological and/or physical parameters of the user;
transmitting (S50) the first data (250) and/or the second data (290) to an assessment module (400);
generating (S60) a user-specific assessment function (470) from the first data (250) and the second data (290) by means of a software application (450) and transmitting the user-specific assessment function (470) to an output module (700);
creating (S70) output data (770) by means of a software application (750) of the output module (700), wherein the software application (750) assesses the generated scenarios with the user-specific assessment function (470) and generates user-specific output data (770) therefrom;
outputting (S80) the user-specific output data (770) to the user.

2. The method of claim 1, wherein the first sensors (340) of the sensor apparatus (300) comprise one or more radar systems with one or more radar sensors, and/or one or more LIDAR systems for optical distance and speed measurement, and/or one or more image-recording 2D/3D cameras in the visible range and/or in the IR range and/or in the UV range, and/or GPS systems, and wherein one or more of the second sensors (270) is/are designed as a blood pressure monitor and/or heart rate monitor and/or temperature gage and/or acceleration sensor and/or speed sensor and/or capacitive sensor and/or inductive sensor and/or voltage sensor.

3. The method of claim 1, wherein the software application (450) of the assessment module (400) and/or the software application (550) of the scenario module (500) and/or the software application (750) of the output module (700) comprise(s) artificial intelligence and machine learning algorithms and/or at least one reinforcement learning agent (LV) for generating the user-specific assessment function (470) and/or for generating scenarios from the recorded sensor data (350) and/or for generating output data (770).

4. The method of claim 1, wherein further data from a database (850) are used to generate the output data (770).

5. The method of claim 1, wherein the assessment module (400), the scenario module (500) and the output module (700) are integrated in a cloud computing infrastructure (800), and a 5G mobile radio connection or 6G mobile radio connection is used for the data connection of the sensor apparatus (300) to the scenario module (500) or the cloud computing infrastructure (800) and for the data connection of the input module (200) to the assessment module (400) or the cloud computing infrastructure (800) for real-time data transmission.

6. The method of claim 1, wherein a first version of the assessment function (470) is created in a training phase by means of a training set of user-specific data (250, 290).

7. The method of claim 1, wherein the output data (770) are voice messages, warning tones and/or music titles.

8. The method of claim 1, wherein the scenarios are designated by labels for a classification by the assessment function (470).

9. A system (100) for interactive communication between a moving object (10) and a user when traveling along a route with a variety of scenarios, wherein a scenario represents a traffic event in a temporal sequence, the system comprising:
an input module (200), a sensor apparatus (300), an assessment module (400), a scenario module (500), and an output module (700);
the sensor apparatus (300) being designed to capture sensor data (350) relating to an environment of the moving object (10) by means of first sensors (340) of a sensor apparatus (300) of the moving object (10) and to transmit the sensor data (350) to the scenario module (500);
the scenario module (500) being designed to generate at least one scenario from the sensor data (350) for the traffic event in an environment of the moving object (10) by means of a software application (550) and to transmit the generated scenario to an output module (700);
the input module (200) being designed to capture first user-specific data (250) in the form of voice messages, text messages and/or images, and/or second user-specific data (290) in the form of measurement signals from second sensors (270), the first user-specific data (250) being input by a user by means of a user interface (240), and the second sensors (270) measure physiological and/or physical parameters of the user and transmit the first data (250) and/or the second data (290) to an assessment module (400);
the assessment module (400) generating a user-specific assessment function (470) from the first data (250) and the second data (290) by means of a software application (450) and the transmitting the user-specific assessment function (470) to the output module (700);
the output module (700) creating output data (770) by means of a software application (750) that assesses the generated scenarios with the user-specific assessment function (470) and generates user-specific output data (770) therefrom; and the output module outputting the user-specific output data (770) directly or indirectly to the user by means of a transmission apparatus.

10. The system (100) of claim 9, wherein the first sensors (340) of the sensor apparatus (300) comprise one or more radar systems with one or more radar sensors, and/or one or more LIDAR systems for optical distance and speed measurement, and/or one or more image-recording 2D/3D cameras in the visible range and/or in the IR range and/or in the UV range, and/or GPS systems, and wherein one or more of the second sensors (270) is/are designed as a blood pressure monitor and/or heart rate monitor and/or temperature gage and/or acceleration sensor and/or speed sensor and/or capacitive sensor and/or inductive sensor and/or voltage sensor.

11. The system (100) of claim 9, wherein the software application (450) of the assessment module (400) and/or the software application (550) of the scenario module (500) and/or the software application (750) of the output module (700) comprise(s) artificial intelligence and machine learning algorithms, in particular deep learning with, for example, at least one convolutional neural network (CNN) and/or at least one reinforcement learning agent (LV), for generating the user-specific assessment function (470) and/or for generating scenarios from the recorded sensor data (350) and/or for generating output data (770), and wherein further data from a database (850) are used to generate the output data (770).

12. The system (100) of claim 9, wherein the assessment module (400), the scenario module (500) and the output module (700) are integrated in a cloud computing infrastructure (800), and wherein a 5G mobile radio connection or 6G mobile radio connection is used for the data connection of the sensor apparatus (300) to the scenario module (500) or the cloud computing infrastructure (800) and for the data connection of the input module (200) to the assessment module (400) or the cloud computing infrastructure (800) for real-time data transmission.

13. The system (100) of claim 9, wherein a first version of the assessment function (470) is created in a training phase by means of a training set of user-specific data (250, 290).

14. The system (100) of claim 9, wherein the output data (770) are audio sequences comprising at least one of voice messages, warning tones and/or music titles.

15. A computer program product (900) comprising a non-transitory executable program code (950) that is configured to carry out the method of claim 1 when executed.
